(19) United States
(12) Patent Application Publication
(10) Pub. No.: US 2008/0054114 A1
(43) Pub. Date: Mar. 6, 2008

(54) Nonstick shredder blades

(75) Inventor: Tie Chun Wang, SanChung City (TW)

Correspondence Address: BACON & THOMAS, PLLC, 625 SLATERS LANE, FOURTH FLOOR, ALEXANDRIA, VA, 22314, US

(73) Assignee: Michilin Prosperity Co., Ltd., SanChung City (TW)

(21) Appl. No.: 11/797,522

(22) Filed: May 4, 2007

(30) Foreign Application Priority Data
Sep. 4, 2006 (TW) 095215661

(51) Int. Cl. B02C 7/12

(52) U.S. Cl. 241/291

(57) ABSTRACT

This invention discloses a nonstick shredder blade. The surface of the shredder blade is coated with a nonstick material such as Teflon to enhance its physical properties such as nonstickness and self-lubrication, so that other materials do not stick thereon. This helps the normal operation of the shredder by preventing paper jams.

### BACKGROUND OF THE INVENTION

1. Field of Invention

The invention relates to a shredder and, in particular, to a shredder blade coated with a nonstick layer coated thereon.

2. Related Art

FIG. 1 shows a shredder used for shredding paper. It has several cutting blades 1 separated by spacers 2 mounted on rotary shafts 3. A set of motor and a gear box (not shown) drives the two parallel rotary shafts 3 rotating in opposite directions. The passing paper is then cut into thin, long pieces by the shearing force. According to the mechanical cutting method, there are two types of shredders: stripe-cut shredders and cross-cut shredders. The former have cutting blades regularly disposed on the rotary shafts and cut paper into long stripes in the vertical direction. The latter have more than one hook-like blades disposed in a spiral pattern on the rotary shafts. The paper is not only cut into stripes in the vertical direction, it is also cross-cut into small pieces in the horizontal direction.

When the cutting blades of the above-mentioned shredders encounter self-adhesive paper or paper with single-sided/double-sided tapes, it is most likely that some pieces of paper stick on the cutting blades. This does not only affect the cutting function of the blades, but even results in paper jam. The most serious case is that the user has to disassemble the entire machine in order to clean the paper stuck on the blades.

### SUMMARY OF THE INVENTION

An objective of the invention is to provide a nonstick shredder blade which is less likely for paper to stick thereon even if the passing paper is sticky, as in the case of self-adhesive paper. This helps guarantee the normal operation of the shredder by preventing paper jams.

To achieve the above-mentioned objective, the disclosed nonstick shredder blade is coated with a nonstick material such as Teflon. This enhances the physical properties of nonstickness and self-lubrication for the cutting blades. Other materials are less likely to stick on the blade surfaces, preventing paper jams.

### BRIEF DESCRIPTION OF THE DRAWINGS

The invention will become more fully understood from the detailed description given herein below illustration only, and thus is not limitative of the present invention, and wherein:

FIG. 1 is a schematic view of the shredder blades.

### DETAILED DESCRIPTION OF THE INVENTION

The present invention will be apparent from the following detailed description, which proceeds with reference to the accompanying drawings, wherein the same references relate to the same elements.

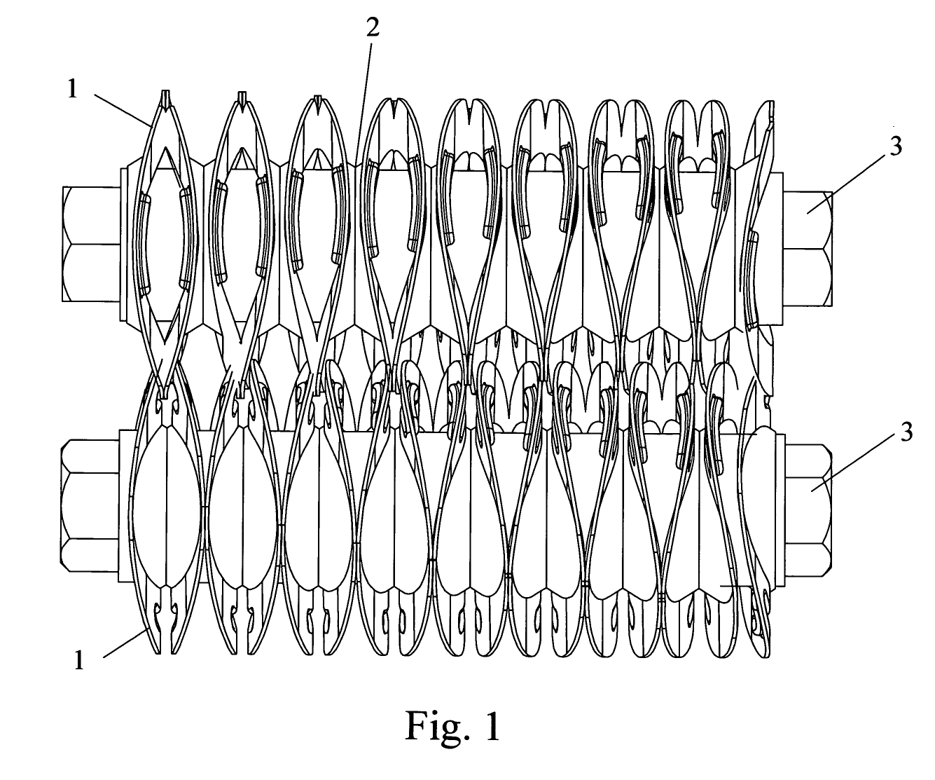

The primary feature of the invention is to coat a nonstick layer on the shredder blade 1 shown in FIG. 1. A typical nonstick material is polytetrafluoroethylene (PTFE), the well-known Teflon. Teflon is the trademark obtained by DuPont, Inc. for PTFE. The four hydrogen atoms in ethylene are replaced by fluorine atoms, followed by polymerization. Since Teflon consists of carbon and fluorine atoms and contains no hydrogen, it does not react with oxygen atoms. Teflon has the nice properties of heat resistant, low-temperature resistant, erosion resistant, superior nonstickness (low surface tension), and self-lubrication (low frictional coefficient). The fluorine atoms surrounding the molecule are the primary reason for the slick surface of Teflon. Since the fluorine atoms almost repel all materials, nothing sticks onto Teflon.

Once the shredder blade is coated with a nonstick layer, sticky paper such self-adhesive paper will not stick on the surface of the blade. Therefore, paper jams can be avoided and the shredder can function normally.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A nonstick shredder blade with a nonstick layer coated thereon.

2. The nonstick shredder blade of claim 1, wherein the material of the nonstick layer is polytetrafluoroethylene (PTFE).
